(19) United States
(12) Patent Application Publication
(10) Pub. No.: US 2009/0263585 A1
(43) Pub. Date: Oct. 22, 2009

(54) COLD-FORMING OF POLYMERS COMPRISING STYRENE

(75) Inventors: Christian Schade, Ludwigshafen (DE); Hans-Jurgen Renner, Neuhofen (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/299,147

(22) PCT Filed: Apr. 30, 2007
(86) PCT No.: PCT/EP07/54207

§ 371 Date: Oct. 31, 2008

(30) Foreign Application Priority Data
May 2, 2006 (EP) 06113383.1

(51) Int. Cl. B05D 3/12

(52) U.S. Cl. 427/366

(57) ABSTRACT

The invention relates to a process for conversion of polymers selected from the group (A) of the polymers comprising styrene, with the exception of homopolystyrene, or from the group (B) of the polymers comprising maleimide to a condition of ductile deformability, which comprises the action of a force on the polymers below their respective glass transition temperature.

The present patent application relates to a process for conversion of polymers comprising styrene or comprising maleimide to a condition of ductile deformability via the action of a force, and also to a process in which, following the conversion to the state of ductile deformability, the polymers are formed in a further step.

Polymers comprising styrene are used in a wide variety of applications, e.g. in the furniture industry or in the automobile industry. Foils comprising styrene can in particular be used for the protection and the finishing of surfaces and, by way of example, picture frames or doors or items of furniture can be covered with a plastics foil (an example being the applicant's PermaSkin® process) instead of painting. Plastics foils are also used for production of bodywork parts (PFM®=the applicant's paintless-film-molding process). Another example from furniture construction is provided by the use of edgebanding products to cover the edges of items of furniture.

In processes used hitherto, the foils here are processed below the glass transition temperature (TG) of the corresponding polymers. The foils here are deformed in such a way as to match the shape of the substrate. A phenomenon that can occur as a function of the mechanical stress or action of forces, i.e. bending angle or bending radius, is that known as stress whitening. This phenomenon forms regions with small hair cracks (“crazes”) in which the polymer has undergone insufficient ductile deformation. These crazes indicate the start .of failure of the material. These zones generally have relatively little resistance to further stress or to attack by a fluid that causes stress cracking.

For the purposes of the present invention, ductility or ductile deformability of the polymers is the plastic deformability of the polymers without occurrence of stress whitening. Ductile deformability or ductility means that a substance can be plastically deformed under the action of a force without occurrence of damage or fracture.

In the case of polymers which are actually transparent, stress whitening behavior is visible in the occurrence of cloudy regions, and in the case of colored foils white spots can be seen. These defects are undesirable for esthetic reasons, in particular in. a design-oriented sector such as furniture construction, especially since they indicate the start of failure of the material. The defects are usually eliminated via heating, and this can be achieved by means of irradiation in the infrared region. Insufficient ductility can also impair the gloss of polymers with high surface gloss during forming processes. Here again, undesirable and problematic optical defects occur.

Meijer et al. (Polymer 42 (2001) 1271; Polymer 44 (2003) 1171) have studied the deformation behavior of polystyrene below TG. They showed that polystyrene can undergo ductile deformation for a short time after prior mechanical stressing. This is a temporary effect. The mechanical stressing consisted in rolling of the test specimens and this led to 32% thickness reduction. In subsequent compression tests, the shear-related softening which is mentioned as cause of occurrence of defects during deformation has disappeared almost completely in the pretreated specimens, unlike in the untreated and, respectively, aged specimens. In tensile strain tests, the pretreated specimens could be stretched homogeneously by up to about 20% before cracking began, but untreated or re-aged specimens cracked at about 2% tensile strain, even before the flow limit had been reached. Ductile flow is present if the specimens can be deformed by at least 6%. Rods composed of amorphous homopolystyrene (“standard polystyrene”) can generally not be satisfactorily formed until the rolls in the pretreatment process have been heated to certain temperatures, often about 40° C., and the rotation rate of the rolls has been lowered to 0.2 s⁻¹. Immediately after the rolling of the dumbbell specimens, it is in principle possible to achieve substantial deformation, for example via repeated twisting in the manner of a spiral. However, the test specimens are generally cloudy after the forming process and exhibit numerous splits. The cloudy regions represent stress whitening and alongside the splits indicate that the test specimens have not undergone ductile deformation. It can be said that this process is therefore unsuitable for the forming of standard polystyrene at temperatures below its glass transition temperature.

It is an object of the present invention to provide a process for conversion of polymers from the group (A) of the polymers comprising styrene, with the exception of homopolystyrene, and from the group (B) of the polymers comprising maleimide to a condition of ductile deformability, thus permitting deformation of the polymers without stress whitening. If the polymers are further processed after conversion to the condition that can undergo ductile deformation, the intention is that they exhibit no defects after the further processing. The process is preferably intended to be feasible at low temperatures, in particular below the respective glass transition temperature.

This object is achieved via a process for conversion of polymers from the group (A) of the polymers comprising styrene, with the exception of homopoly-styrene, and from the group (B) of the polymers comprising maleimide to a condition of ductile deformability, which comprises action of a force on the polymers below their respective glass transition temperature, to an extent permitting deformation without stress whitening.

Surprisingly, it has been found that the inventively used polymers become capable of ductile deformation via the action of the force, i.e. they can be deformed without stress whitening. A consequence of this is that—after prior action of a force—transparent polymers can be formed with retention of their full transparency, i.e. without occurrence of optically problematic, cloudy defects. Colored polymers can be formed without production of pale or white spots, and polymers with high surface gloss can be formed without losing their gloss.

Stress whitening can be determined via optical methods and methods using (electron) microscopes. However, the polymer is usually studied visually, since the human eye has sufficient sensitivity. In the case of transparent products the effect known as haze appears, and finally white clouding occurs. In the case of colored products, the increase in the proportion of scattered light makes the corresponding site paler. White products lose gloss.

Although quantification is possible only by way of optical methods or methods using (electron) microscopes, this visual check is sufficient. For the purposes of the present invention, the expression “without stress whitening” therefore indicates the condition in which the polymer obtained after the process exhibits no stress whitening which can be determined by the person skilled in the art via a visual check or which is classified as problematic for the planned application.

The condition of ductile deformability brought about via the action of the force is not longlasting, and the ductile deformability decreases as time progresses. The precise period of ductile deformability depends on the polymer or polymer mixture used and also on the intensity of the action of the force.

In the present invention, group (A) polymers comprising styrene are polymer mixtures, copolymers, and homopolymers comprising at least styrene or comprising at least one styrene derivative, but with the exception of homopolystyrene. The polymer mixtures, copolymers, and homopolymers comprising styrene or comprising styrene derivatives, with the exception of homopolystyrene, can comprise, as monomer components, further monomer types known to the person skilled in the art.

The term homopolymer is used for a polymer which comprises only one single type of monomer as monomer component. Accordingly, homopolystyrene means a polymer which comprises styrene as single monomer.

In the present invention, group (B) polymers comprising maleimide are polymers, copolymers, and polymer mixtures which comprise, at least as one monomer component, maleimide or maleimide derivatives. The polymers of group (B) can comprise, as monomer components, further monomer types known to the person skilled in the art.

Copolymers can be random copolymers, block copolymers composed of two, three, or more blocks, star copolymers, graft copolymers, or core-shell copolymers having two, three, or more layers.

Polymer mixtures are mixtures composed of homopolymers, of copolymers, or else of co- and homopolymers. The polymer mixtures can comprise two, three or more polymer components. The polymer mixtures can be present in the form of a homogeneous or heterogeneous mixture.

The inventively used polymers can comprise further conventional additions known to the person skilled in the art, examples being processing aids, fillers, color pigments and dyes, antioxidants, heat stabilizers, antistatic agents, flame retardants, and the like.

In the present invention, styrene is styrene per se. Styrene derivatives are monomers known to the person skilled in the art, comprising, for example, styrene substituted by alkyl radicals comprising from 1 to 8 carbon atoms like vinyltoluenes there under α-methylstyrene and α-chlorostyrene and also mixtures of these monomers.

Another monomer component that can be used is provided by conventional monomers known to the person skilled in the art, examples being aliphatic, aromatic, and araliphatic esters of acrylic acid and methacrylic acid, acrylonitrile, methacrylonitrile, maleic anhydride, maleimide, dienes, such as butadiene or isoprene, and olefinic monomers and also mixtures thereof.

The term maleimide is used in the present invention for maleimide per se and also for derivatives thereof. Among these derivatives known to the person skilled in the art are, for example, N-alkylmaleimides, N-acrylic maleimides, and N-aryl-maleimides. It is preferable to use copolymers and polymer mixtures, e.g. SAN (styrene-acrylonitrile), HIPS (high impact polystyrene), ASA (acrylonitrile/styrene/acryl amide), SBC (styrene-butadiene block copolymers), SMA (styrene-maleic anhydride copolymer), and also SMMA (styrene-methyl methacrylate). The polymers used can also have been impact-modified.

The inventive action of the force on the polymers comprising styrene, with the exception of homopolystyrene, and on the polymers comprising maleimide can be achieved via compression, bending, extension, kneading, general exposure to shear fields, twisting, or rolling, and it is preferable that the polymers are converted into the condition of ductile deformability by means of rolling. Suitable preliminary experiments are used to determine the necessary parameters, such as duration and intensity of the action of the force, for the various polymers, copolymers and polymer mixtures, and also for the various types of action of the force. This means that, as a function of selected polymer and selected type of action of the force, tests are carried out at various settings until it is possible to form the polymer subsequently without stress whitening.

In the case of action of the force via rolls, the rolling procedures are generally adjusted via selection of the gap width and of the rotation rate of the rolls. The precise settings needed can be determined via preliminary experiments. The selection of the gap is preferably such that the rolls lead to a thickness reduction of at least 5%, particularly preferably at least 10%, very particularly preferably at least 15%. The rotation rate of the rolls is from 0.001 Hz to 20 Hz, preferably from 0.01 Hz to 5 Hz, particularly preferably from 0.05 Hz to 1 Hz. Hz here is equivalent to s⁻¹, both meaning roll rotations per second.

The rolls are cylindrical rotating bodies with a smooth, grooved, or contoured surface. It is preferable to use metallic rolls with a smooth surface.. They are preferably resistant to bending and they preferably have adequate surface hardness. By way of example, they are produced via chilled casting or from steel with a hardened surface. They are preferably heatable. The roll diameters are in the range from a few mm to more than 1 m.

The conversion to the condition of ductile deformability via the action of a force is usually carried out at room temperature. However, it can also be undertaken at slightly elevated temperatures. The temperature here is not to exceed the glass transition temperature of the respective polymer. In the case of polymer mixtures, the individual components can have different glass transition temperatures, and by way of example this is the case with polymer mixtures modified by means of rubber; some of the polymers used as rubber modifiers have glass transition temperatures of 0° C. and lower. If heterogeneous polymer mixtures, i.e. polymer mixtures present in two or more phases, exhibit two glass transition temperatures, the present invention relates to the glass transition temperature of the polymer, copolymer, or polymer mixture forming the matrix phase.

The temperature at which the force acts is preferably below T_{G} by at least 10° C., particularly preferably below T_{G} by at least 30° C., very particularly preferably below T_{G} by at least 60° C.

According to one preferred embodiment of the present invention, forming of the polymers can take place after conversion of the polymers comprising styrene, with the exception of homopolystyrene, and of the polymers comprising maleimide into a condition of ductile deformability. According to the inventive process, the period between the action of the force and forming of the polymers comprising styrene, with the exception of homopolystyrene, and of the polymers comprising maleimide is selected in such a way that the polymers retain ductile deformability. The possible interval between the action of the force and forming can be determined via suitable preliminary experiments, but the polymers are preferably formed directly after the action of the force.

The forming process can, by way of example, be carried out by means of processes known to the person skilled in the art, examples being calendering, bending, embossing, and drawing processes, such as thermoforming.

The polymers converted according to the invention into the condition of ductile deformability by means of action of the force can be deformed without occurrence of defects in the polymers during this process, and feature flexural behavior without stress whitening, i.e. bending of transparent polymers gives no cloudy sites, and colored polymers can be deformed without occurrence of white spots. The surface gloss of the polymers is moreover retained.

The polymers converted to the ductile condition according to the inventive process can by way of example be processed in the form of foils in many applications, example being the PermaSkin process; picture frames or windows, doors, or items of furniture can be provided with a polymer coating. Further processing without stress whitening makes the inventively pretreated polymers suitable for use in design-oriented sectors where high value is placed upon the appearance of the products. Examples of these are the furniture industry, the automobile industry or the packaging industry. The inventive process using the polymers provides greater freedom in design and in selection of shape.

According to the inventive process, the polymers, in particular in the form of foils, can also be used to mold three-dimensional articles. Examples of these are decorative packaging and protective packaging for various products, such as foods, small parts, cosmetics, small devices, and intermediate packaging for protection from damage during transport, inserts for small-parts storage, toys, kitchenware composed of plastic, or hollow articles such as window boxes. There is no restriction on the size of the shaped products produced from the inventively pretreated polymers. The ductile polymers can also be used to mold large structures, such as sandboxes.

The process is also suitable for extruded polymers or polymer mixtures which are then, following the extrusion process, subjected to a shaping process. By way of example, profiles and semifinished products, such as pipes, can be processed according to the inventive process.

Examples will be used to illustrate the inventive processes below.

### EXAMPLES

Examples 1 to 4 were carried out using dumbbell specimens of thickness 4 mm, and example 5 used a foil of thickness 0.3 mm. The roll separation was 2 mm unless otherwise stated.

### Example 1

Standard polystyrene whose molecular weight is 265 000 dalton (non-inventive):

A) Rolling at room temperature with a roll rotation rate of 0.2 Hz:

Cold rolling in most cases gives fracture and dumbbell specimens with splits.

B) Rolling at 40° C. with a roll rotation rate of 0.2 Hz:

Immediately after rolling of the dumbbell specimens, extensive deformation was possible, for example via multiple twisting in the manner of a spiral. However, the test specimens were cloudy after the forming process and exhibited numerous splits.

C) Rolling at 40° C. with a roll rotation rate of 0.2 Hz, 1 min. of standing time:

Twisting had become impossible without fracture.

### Example 2

Forming of polymers comprising styrene and comprising at least one further monomer:

A) Deformation without pretreatment via rolling (non-inventive):
a) SAN whose average molecular weight is 180 000 dalton and whose styrene:acrylonitrile ratio is 75:25

Twisting of the test specimens led to fracture, cracking, or pronounced stress-whitening behavior.
b) HIPS composed of a blend of PS whose average molecular weight is 265 000 dalton and of an HIPS whose average molecular weight is 187 000 dalton with a polybutadiene content of 8% by weight in a ratio of 1:1

Twisting of the test specimens led to fracture, cracking, or pronounced stress-whitening behavior.
c) ASA whose average matrix molecular weight is 160 000 dalton and whose styrene:acrylonitrile:butyl acrylate ratio is 55:25:20

Twisting of the test specimens led to fracture, cracking, or pronounced stress-whitening behavior.

B) Pretreatment of specimens via rolling at room temperature with roll rotation rate of 0.2 Hz (inventive):
a) SAN as in example 2 A) a)

The test specimens were very readily capable of ductile deformation, for example via multiple twisting in the manner of a spiral. No stress-whitening behavior could be observed on the test specimens, some of which had a high degree of twisting. No splitting was observable. After the forming process, the test specimens were transparent, with no clouding.
b) HIPS as in example 2 A) b)

The test specimens were very readily capable of ductile deformation, for example via multiple twisting in the manner of a spiral. No stress-whitening behavior could be observed on the test specimens, some of which had a high degree of twisting. No splitting was observable. After the forming process, the test specimens exhibited high gloss.
c) ASA as in example 2 A) c)

The test specimens were very readily capable of ductile deformation, for example via multiple twisting in the manner of a spiral. No stress-whitening behavior could be observed on the test specimens, some of which had a high degree of twisting. No splitting was observable. After the forming process, the test specimens were transparent, with no clouding.

### Example 3

Study of the effect of roll separation using ASA from example 2 A) c) with roll separation of 3.5 mm at 30° C. and a roll rotation rate of 0.2 Hz:

The dumbbell specimens were capable of ductile deformation without stress whitening.

### Example 4

Duration of ductile deformability, using HIPS as in example 2 A) b), at 40° C. with a roll rotation rate of 0.2 Hz:

The dumbbell specimens could still be twisted up to 10 minutes after the pretreatment.

### Example 5

Production of picture frames via covering of a rectangular aluminum profile with a colored foil composed of ASA as in example 2 A) c)

A) No pretreatment (non-inventive):

When severe bending radii were used, stress whitening sometimes occurred and is clearly visible in the case of dark colors, thus impairing the perceived quality or indeed the function of the foil.

B) Pretreatment via rolling at 40° C. using a roll gap of 0.1 mm and a roll rotation rate of 0.15 Hz (inventive):

The prerolled foil exhibited only an extremely low susceptibility to stress whitening in the severely stressed corner region.

1. A process for providing a surface with a polymer coating by conversion of polymers selected from the group (A) of the polymers comprising styrene, with the exception of homopolystyrene, or from the group (B) of the polymers comprising maleimide to a condition of ductile deformability, which comprises the action of a force on the polymers below their respective glass transition temperature, and subsequently providing the coating.

2. The process according to claim 1, wherein the polymers are processed in the form of foils.

3. The process according to claim 1, wherein the action of the force takes place via rolls.

4. The process according to claim 3, wherein the rolling process leads to a thickness reduction of at least 5%.

5. The process according to claim 3, wherein the rolling process leads to a thickness reduction of 10%.

6. The process according to claim 1, wherein the polymers have been selected from the group (A) of the polymer mixtures, copolymers, and homopolymers comprising styrene and comprising its derivatives, with the exception of homopolystyrene, or from the group (B) of the polymer mixtures, copolymers, and homopolymers comprising maleimide and comprising its derivatives.

7. The process according to claim 5, wherein the polymers are copoly(styrene/acrylonitrile), high impact polystyrene, copoly(acrylonitrile/styrene/acryl amide), block-copoly (styrene/butadiene), copoly(styrene/maleic anhydride), and copoly(styrene/methylmethacrylate).

8. A coating obtainable by the process of claim 1.

9. The process according to claim 2, wherein the action of the force takes place via rolls.

10. The process according to claim 2, wherein the polymers have been selected from the group (A) of the polymer mixtures, copolymers, and homopolymers comprising styrene and comprising its derivatives, with the exception of homopolystyrene, or from the group (B) of the polymer mixtures, copolymers, and homopolymers comprising maleimide and comprising its derivatives.

11. The process according to claim 3, wherein the polymers have been selected from the group (A) of the polymer mixtures, copolymers, and homopolymers comprising styrene and comprising its derivatives, with the exception of homopolystyrene, or from the group (B) of the polymer mixtures, copolymers, and homopolymers comprising maleimide and comprising its derivatives.

12. The process according to claim 4, wherein the polymers have been selected from the group (A) of the polymer mixtures, copolymers, and homopolymers comprising styrene and comprising its derivatives, with the exception of homopolystyrene, or from the group (B) of the polymer mixtures, copolymers, and homopolymers comprising maleimide and comprising its derivatives.

13. The process according to claim 5, wherein the polymers have been selected from the group (A) of the polymer mixtures, copolymers, and homopolymers comprising styrene and comprising its derivatives, with the exception of homopolystyrene, or from the group (B) of the polymer mixtures, copolymers, and homopolymers comprising maleimide and comprising its derivatives.

14. A coating obtainable by the process of claim 2.

15. A coating obtainable by the process of claim 3.

16. A coating obtainable by the process of claim 4.

17. A coating obtainable by the process of claim 5.

18. A coating obtainable by the process of claim 6.

19. A coating obtainable by the process of claim 7.

20. The process according to claim 6, wherein the polymers are copoly (styrene/acrylonitrile), high impact polystyrene, copoly(acrylonitrile/styrene/acrylomide), block-copoly (styrene/butadiene), copoly(styrene/maleic anhydride), and copoly(styrene/methylmethacrylate).
